(19) United States
(12) Patent Application Publication
(10) Pub. No.: US 2026/0331055 A1
(43) Pub. Date: Oct. 22, 2026

(54) DISPLAY DEVICE

(71) Applicant: Wuhan China Star Optoelectronics Semiconductor Display Technology Co., Ltd., Wuhan (CN)

(72) Inventors: Yanjun GUAN, Wuhan (CN); Tao CHEN, Wuhan (CN); Wei WANG, Wuhan (CN)

(73) Assignee: Wuhan China Star Optoelectronics Semiconductor Display Technology Co., Ltd., Wuhan (CN)

(21) Appl. No.: 19/704,535

(22) Filed: Jun. 11, 2026

(30) Foreign Application Priority Data
Dec. 29, 2025 (CN) 202512017150.4

(51) Int. Cl. G09G 3/3233

(52) U.S. Cl. CPC G09G 3/3233; G09G 2300/0842; G09G 2310/08; G09G 2320/0242; G09G 2320/0247; G09G 2330/021; G09G 2340/0435

(57) ABSTRACT

A display device, including a first transistor, a fourth transistor, a fifth transistor, a sixth transistor, and a seventh transistor. The gate of the seventh transistor is electrically connected to a third scan signal line, the source or drain of the seventh transistor is electrically connected to a second reset signal line, and the other of the source and drain of the seventh transistor is electrically connected to the source or drain of the first transistor. Before the light-emitting device emits light in the first stage, the display device controls the fourth transistor to turn off and the sixth transistor to turn on, resetting the other of the source and drain of the first transistor through the other of the source and drain of the sixth transistor.

### RELATED APPLICATION

This application claims the benefit of priority of Chinese Patent Application No. 202512017150.4, filed on Dec. 29, 2025, the contents of which are all incorporated by reference as if fully set forth herein in their entirety.

### TECHNICAL FIELD

The present invention relates to the technical field of display, and more specifically to a display device.

### BACKGROUND

An active matrix organic light-emitting diode (AMOLED) display panel typically includes multiple pixels, each pixel including a light-emitting device and a pixel driving circuit configured to control the light emission of the light-emitting device.

### SUMMARY

This application provides a display device, which includes a display panel. The display panel includes multiple pixels, multiple third scan signal lines, multiple first light-emitting control signal lines, multiple second light-emitting control signal lines, at least one first power supply signal line, multiple first reset signal lines, and multiple second reset signal lines. Each pixel includes a light-emitting device and a pixel driving circuit. The pixel driving circuit includes a first transistor, a fourth transistor, a fifth transistor, a sixth transistor, and a seventh transistor. The gate of the fourth transistor is electrically connected to the second light-emitting control signal line. One of the source and drain of the fourth transistor is electrically connected to the first reset signal line. The other of the source and drain of the fourth transistor is electrically connected to the other of the source and drain of the sixth transistor. The gate of the fifth transistor is electrically connected to the first light-emitting control signal line. One of the source and drain of the fifth transistor is electrically connected to the first power supply signal line. The other of the source and drain of the fifth transistor is electrically connected to one of the source and drain of the first transistor. The gate of the sixth transistor is electrically connected to the second light-emitting control signal line. One of the source and drain of the sixth transistor is electrically connected to the other of the source and drain of the first transistor. The other of the source and drain of the sixth transistor is electrically connected to the anode of the light-emitting device. The gate of the seventh transistor is electrically connected to the third scan signal line. One of the source and drain of the seventh transistor is electrically connected to the second reset signal line. The other of the source and drain of the seventh transistor is electrically connected to the other of the source and drain of the first transistor. When the display device switches from a first refresh rate to a second refresh rate, the driving cycle for displaying one frame at the second refresh rate includes a first stage and a second stage, where the first refresh rate is higher than the second refresh rate. In the first stage, the display device is configured to control the fourth transistor to turn off and the sixth transistor to turn on before the light-emitting device emits light, so as to reset the other of the source and drain of the first transistor via the other of the source and drain of the sixth transistor.

### BRIEF DESCRIPTION OF THE DRAWINGS

FIG. 1 is a schematic diagram of a display device according to an embodiment of this application.

FIG. 2 is a circuit diagram of the pixel driving circuit of the display device according to an embodiment of this application.

FIG. 3 is a timing diagram of the first stage of the driving cycle of the display device when switching from a first refresh rate to a second refresh rate according to an embodiment of this application.

FIG. 4 is a timing diagram of the second stage of the driving cycle of the display device when switching from a first refresh rate to a second refresh rate according to an embodiment of this application.

### DETAILED DESCRIPTION OF THE EMBODIMENTS

The specific embodiments of this application will now be described in detail with reference to the accompanying drawings.

The terms “first”, “second” and similar words do not indicate any order, quantity, or importance, but are merely used to distinguish different technical features. The terms “multiple” and similar words mean two or more, unless otherwise expressly specified.

The technical solutions of different embodiments of this application can be combined with each other.

An objective of this application is to provide a display device that addresses the technical problem of brightness flickering during refresh rate switching.

To meet the needs of different application scenarios, display devices typically support Variable Refresh Rate (VRR) functionality, meaning the display device is configured to adjust the refresh rate according to changes in the displayed content. For example, the display device has a lower refresh rate when displaying static images and a higher refresh rate when displaying dynamic images.

In a pixel driving circuit, the source and drain of the driving transistor are electrically connected to different nodes. Due to the layout and device structure of the pixel driving circuit, the parasitic capacitance of the node connected to the source of the driving transistor differs from the parasitic capacitance of the node connected to the drain of the driving transistor.

When a display device displays an image at a high refresh rate, the driving cycle for displaying one frame is short. During this driving cycle, before the light-emitting device emits light, the pixel driving circuit resets the relevant nodes, making the potentials of these nodes close to each other.

After the display device switches from a higher refresh rate to a lower refresh rate, the driving cycle for displaying one frame is relatively long. This driving cycle includes multiple stages. In some stages of this driving cycle, before the light-emitting device emits light, the potentials of these nodes differ due to the differences in parasitic capacitance of the aforementioned nodes and the coupling effect of the signal lines to the nodes.

During the switching process from a higher refresh rate to a lower refresh rate, the brightness of the light-emitting device changes due to differences in the potential of relevant nodes before the light-emitting device emits light at different stages, resulting in brightness flicker. Furthermore, this potential difference also causes color deviations in the displayed image before and after the refresh rate switch.

Therefore, it is necessary to propose a new technical solution to solve the above-mentioned technical problems.

The display device provided in this application improves the technical problem of brightness flickering during refresh rate switching by providing a seventh transistor and a second reset signal line in the pixel driving circuit, and controlling the fourth transistor to turn off and the sixth transistor to turn on before the light-emitting device emits light in the first stage after the display device switches from the first refresh rate to the second refresh rate, and resetting the other of the source and drain of the first transistor by using the other of the source and drain of the sixth transistor.

Specifically, when the display device displays an image at the first refresh rate, the driving cycle for displaying one frame is relatively short. During this driving cycle, before the light-emitting device emits light, the potentials of the node connected to one of the source and drain of the first transistor and the node connected to the other of the source and drain of the first transistor are close after reset. After the display device switches from the first refresh rate to the second refresh rate, the driving cycle for displaying one frame includes a first stage and a second stage, with the duration of the first stage being shorter than that of the second stage. In the second stage, due to the difference between the parasitic capacitance of the node connected to one of the source and drain of the first transistor and the parasitic capacitance of the node connected to the other of the source and drain of the first transistor, and due to the coupling effect of the second light-emitting control signal line to the node connected to the other of the source and drain of the first transistor, there is a significant difference between the potentials of the node connected to one of the source and drain of the first transistor and the node connected to the other of the source and drain of the first transistor before the light-emitting device emits light. This potential difference causes the brightness of the light-emitting device to change during refresh rate switching, resulting in brightness flickering and causing color deviation in the image displayed on the display device before and after the refresh rate switch.

The display device of this application controls the fourth transistor to turn off and the sixth transistor to turn on before the light-emitting device emits light in the first stage. The other of the source and drain of the sixth transistor resets the other of the source and drain of the first transistor, so that before the light-emitting device emits light in the first stage, the potential of the node connected to the other of the source and drain of the first transistor is close to the potential of the node connected to the other of the source and drain of the sixth transistor. Since the other of the source and drain of the fourth transistor is electrically connected to the other of the source and drain of the sixth transistor, when the fourth transistor turns on, it resets the other of the source and drain of the sixth transistor through the first reset signal line, and the potential of the node connected to the other of the source and drain of the sixth transistor is close to the potential of the first reset signal line. Therefore, before the light-emitting device emits light in the first stage, the potential of the node connected to the other of the source and drain of the first transistor is close to the potential of the first reset signal line. Before the light-emitting device emits light in the first stage, the fifth transistor is turned on, resetting one of the source and drain terminals of the first transistor via the first power supply signal line. This brings the potential of the node connected to one of the source and drain of the first transistor close to the potential of the first power supply signal line. Therefore, before the light-emitting device emits light in the first and second stages, the potential difference between the node connected to one of the source and drain of the first transistor and the node connected to the other is reduced. This reduces the change in brightness of the light-emitting device during refresh rate switching, improves brightness flicker, and reduces color deviation of the displayed image before and after refresh rate switching.

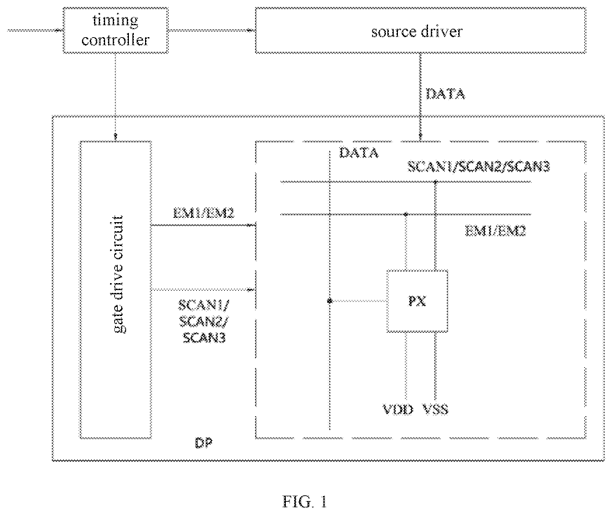

An embodiment of this application provides a display device, as shown in FIG. 1. The display device includes a display panel DP, a timing controller, a power management chip, and a source driver chip. The display panel DP is an active matrix organic light-emitting diode (AMOLED) display panel.

The display panel DP includes a gate drive circuit, multiple pixels PX, multiple first scan signal lines SCAN1, multiple second scan signal lines SCAN2, multiple third scan signal lines SCAN3, multiple first light-emitting control signal lines EM1, multiple second light-emitting control signal lines EM2, multiple data signal lines DATA, multiple first reset signal lines VI, multiple second reset signal lines Vref, at least one first power supply signal line VDD, and at least one second power supply signal line VSS.

The first scan signal line SCAN1, the second scan signal line SCAN2, and the third scan signal line SCAN3 are electrically connected to the gate drive circuit. The data signal line DATA is electrically connected to the source driver chip. The first light-emitting control signal line EM1 and the second light-emitting control signal line EM2 are electrically connected to the gate drive circuit.

The timing controller is configured to receive externally input image data and control signals, and generates timing control signals for controlling the gate driver circuit and the source driver chip based on the image data and control signals. The gate driver circuit outputs corresponding scan signals and light emission control signals to the first scan signal line SCAN1, the second scan signal line SCAN2, the third scan signal line SCAN3, the first light-emitting control signal line EM1, and the second light-emitting control signal line EM2, based on the timing control signals output by the timing controller. The source driver chip is configured to output data signals to the data signal line DATA, based on the timing control signals and image data output by the timing controller.

The display device is configured to support variable refresh rate mode and to use frame skipping to switch refresh rates.

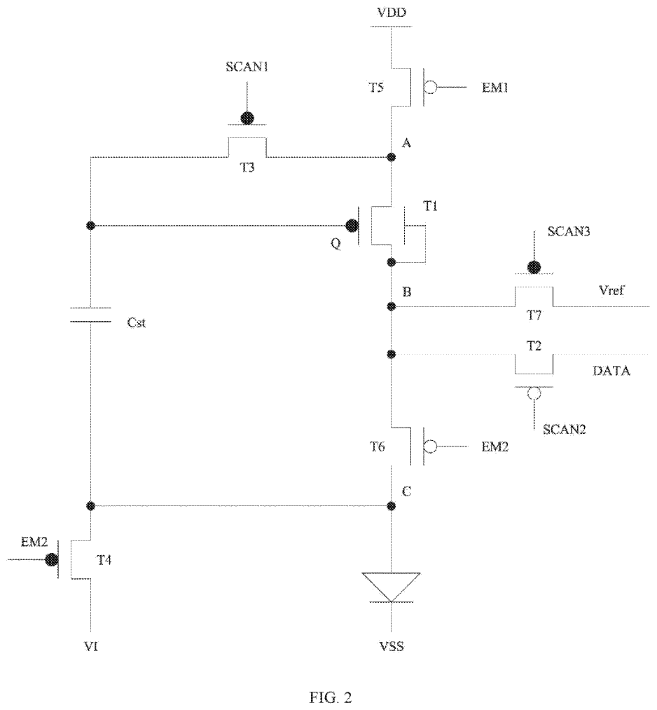

Each pixel PX includes a light-emitting device and a pixel driving circuit. The light-emitting device is an organic light-emitting diode. As shown in FIG. 2, the pixel driving circuit includes a first transistor T1, a second transistor T2, a third transistor T3, a fourth transistor T4, a fifth transistor T5, a sixth transistor T6, a seventh transistor T7, and a storage capacitor Cst.

The first transistor T1 includes a first gate, a second gate, a source, and a drain. The first gate of the first transistor T1 is electrically connected to one of the source and drain of the third transistor T3. The line between the first gate of the first transistor T1 and one of the source and drain of the third transistor T3 includes a second node Q. The first gate of the first transistor T1 is also electrically connected to an end of the storage capacitor Cst. The first transistor T1 is an N-type thin-film transistor. The active layer of the first transistor T1 includes an oxide semiconductor material, which includes indium gallium zinc oxide (IGZO).

One of the source and drain of the first transistor T1 is electrically connected to the other of the source and drain of the third transistor T3. The line between the source and drain of the first transistor T1 and the other of the source and drain of the third transistor T3 includes a third node A. The other of the source and drain of the first transistor T1 is electrically connected to the second gate of the first transistor T1. The second gate of the first transistor T1 is configured to cover the channel of the first transistor T1 to maintain the device characteristics of the first transistor T1.

The gate of the third transistor T3 is electrically connected to the first scan signal line SCAN1. The third transistor T3 is an N-type thin-film transistor, and the active layer of the third transistor T3 includes an oxide semiconductor material, which includes indium gallium zinc oxide.

The gate of the second transistor T2 is electrically connected to the second scan signal line SCAN2. One of the source and drain of the second transistor T2 is electrically connected to the data signal line DATA. The other of the source and drain of the second transistor T2 is electrically connected to the other of the source and drain of the first transistor T1. The other of the source and drain of the second transistor T2 is also electrically connected to one of the source and drain of the sixth transistor T6. The line between the one of the source and drain of the sixth transistor T6 and the other of the source and drain of the first transistor T1 includes the first node B. The second transistor T2 is a P-type thin-film transistor, and the active layer of the second transistor T2 includes low-temperature polysilicon (LTPS).

The gate of the fourth transistor T4 is electrically connected to the second light-emitting control signal line EM2. One of the source and drain of the fourth transistor T4 is electrically connected to the first reset signal line VI. The other of the source and drain of the fourth transistor T4 is electrically connected to the other of the source and drain of the sixth transistor T6. The other of the source and drain of the sixth transistor T6 is electrically connected to the anode of the light-emitting device. The other of the source and drain of the fourth transistor T4 is also electrically connected to the other end of the storage capacitor Cst. The line between the anode of the light-emitting device and the other of the source and drain of the sixth transistor T6 includes a fourth node C. The fourth transistor T4 is an N-type thin-film transistor. The active layer of the fourth transistor T4 includes an oxide semiconductor material, which includes indium gallium zinc oxide.

The gate of the fifth transistor T5 is electrically connected to the first light-emitting control signal line EM1. One of the sources and drains of the fifth transistor T5 is electrically connected to the first power supply signal line VDD. The other of the sources and drains of the fifth transistor T5 is electrically connected to the other of the sources and drains of the third transistor T3. The other of the sources and drains of the fifth transistor T5 is also electrically connected to one of the source and drain of the first transistor T1. The fifth transistor T5 is a P-type thin-film transistor, and the active layer of the fifth transistor T5 includes low-temperature polycrystalline silicon.

The gate of the sixth transistor T6 is electrically connected to the second light-emitting control signal line EM2. The sixth transistor T6 is a P-type thin-film transistor, and the active layer of the sixth transistor T6 includes low-temperature polycrystalline silicon.

The gate of the seventh transistor T7 is electrically connected to the third scan signal line SCAN3. One of the sources and drains of the seventh transistor T7 is electrically connected to the second reset signal line Vref. The other of the sources and drains of the seventh transistor T7 is electrically connected to the other of the sources and drains of the first transistor T1. The other of the sources and drains of the seventh transistor T7 is also electrically connected to one of the sources and drains of the sixth transistor T6. The other of the sources and drains of the seventh transistor T7 is also electrically connected to the other of the sources and drains of the second transistor T2. The seventh transistor T7 is an N-type thin-film transistor. The active layer of the seventh transistor T7 includes an oxide semiconductor material, which includes indium gallium zinc oxide.

The cathode of the light-emitting device is electrically connected to the second power supply signal line VSS.

In the display device, the parasitic capacitance of the other of the source and drain of the first transistor T1 is greater than the parasitic capacitance of the one of the source and drain of the first transistor T1, and the parasitic capacitance of the first node B is greater than the parasitic capacitance of the third node A.

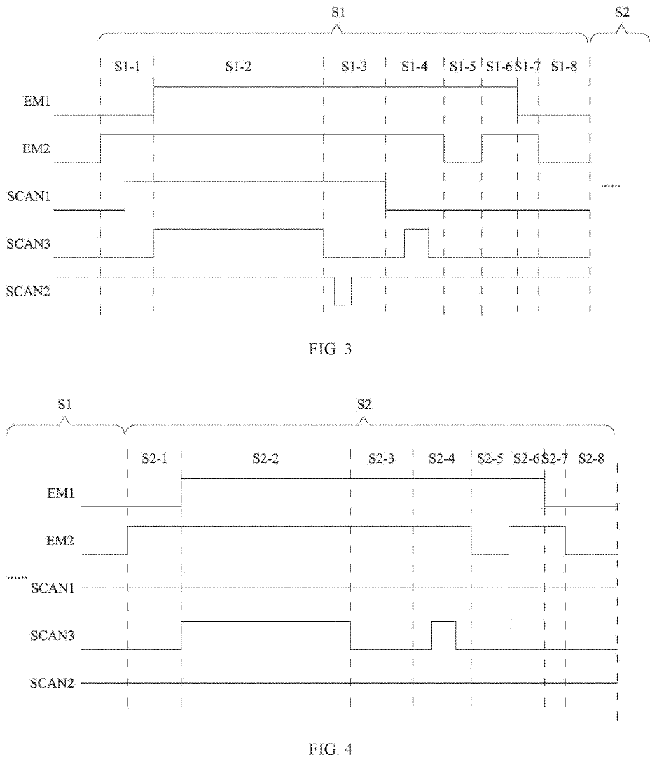

The display device provided in the embodiments of this application adds a seventh transistor T7 to the pixel driving circuit. The seventh transistor T7 is turned on under the control of the third scan signal line SCAN3. The second reset signal line Vref resets the other of the source and drain of the first transistor T1 through the seventh transistor T7, thereby resetting the potential of the node connected to the other of the source and drain of the first transistor T1. As shown in FIGS. 3 and 4, when the display device switches from a first refresh rate to a second refresh rate, the driving cycle for displaying one frame at the second refresh rate includes a first stage S1 and a second stage S2. The first refresh rate is higher than the second refresh rate. In the first stage S1 and the second stage S2, before the light-emitting device emits light, the node connected to the other of the source and drain of the first transistor T1 is reset by the seventh transistor T7. This makes the potential of the node before the light-emitting device emits light in the first stage S1 and the second stage S2 closer, thereby reducing the potential difference of the node connected to the other of the source and drain of the first transistor T1 before the light-emitting device emits light in the first stage S1 and the second stage S2. This further reduces the potential difference between the node connected to the other of the source and drain of the first transistor T1 and the node connected to the source and drain of the first transistor T1 before the light-emitting device emits light in the first stage S1, thereby improving the brightness flicker phenomenon that occurs during the refresh rate switching process of the display device and reducing the color deviation of the image displayed by the display device before and after the refresh rate switching.

In the first stage S1 and the second stage S2, before the light-emitting device emits light, the display device first controls the fourth transistor T4 to turn on, and resets the other of the source and drain of the sixth transistor T6 through the first reset signal line VI. Then, it controls the seventh transistor T7 to turn on, and resets the other of the source and drain of the first transistor T1 through the second reset signal line Vref. Then, it controls the fourth transistor T4 to turn off and the sixth transistor T6 to turn on, and resets the other of the source and drain of the first transistor T1 through the other of the source and drain of the sixth transistor T6. Then, it controls the fifth transistor T5 to turn on, and resets the one of the source and drain of the first transistor T1 through the first power supply signal line VDD. By sequentially resetting the other of the source and drain of the sixth transistor T6, the other of the source and drain of the first transistor T1, and the one of the source and drain of the first transistor T1, the potentials of these nodes before the light-emitting devices emit light in the first stage S1 and the second stage S2 are made close, thereby further reducing the potential difference of the relevant nodes before the light-emitting devices emit light in the first stage S1 and the second stage S2, further improving the brightness flicker phenomenon that occurs in the display device during refresh rate switching, and further reducing the color deviation of the image displayed by the display device before and after refresh rate switching.

In some embodiments, the first transistor T1, the third transistor T3, the fourth transistor T4, and the seventh transistor T7 are N-type thin-film transistors, and the second transistor T2, the fifth transistor T5, and the sixth transistor T6 are P-type thin-film transistors.

In some embodiments, the first stage S1 includes a first sub-stage S1-1, a second sub-stage S1-2, a third sub-stage S1-3, a fourth sub-stage S1-4, a fifth sub-stage S1-5, a sixth sub-stage S1-6, a seventh sub-stage S1-7, and an eighth sub-stage S1-8. In the first sub-stage S1-1, the first light-emitting control signal line EM1 outputs a low level, the second light-emitting control signal line EM2 outputs a high level, the first scan signal line SCAN1 first outputs a low level and then a high level, the second scan signal line SCAN2 outputs a high level, and the third scan signal line SCAN3 outputs a low level. In the second sub-stage S1-2, the first light-emitting control signal line EM1 outputs a high level, the second light-emitting control signal line EM2 outputs a high level, the first scan signal line SCAN1 outputs a high level, the second scan signal line SCAN2 outputs a high level, and the third scan signal line SCAN3 first outputs a low level and then a high level. In the third sub-stage S1-3, the first light-emitting control signal line EM1 outputs a high level, the second light-emitting control signal line EM2 outputs a high level, the first scan signal line SCAN1 outputs a high level, the second scan signal line SCAN2 first outputs a high level, then a low level, then a high level again, and the third scan signal line SCAN3 outputs a low level. In the fourth sub-stage S1-4, the first light-emitting control signal line EM1 outputs a high level, the second light-emitting control signal line EM2 outputs a high level, the first scan signal line SCAN1 outputs a low level, the second scan signal line SCAN2 outputs a high level, and the third scan signal line SCAN3 first outputs a low level, then a high level, then a low level again. In the fifth sub-stage S1-5, the first light-emitting control signal line EM1 outputs a high level, the second light-emitting control signal line EM2 outputs a low level, the first scan signal line SCAN1 outputs a low level, the second scan signal line SCAN2 outputs a high level, and the third scan signal line SCAN3 outputs a low level. In the sixth sub-stage S1-6, the first light-emitting control signal line EM1 outputs a high level, the second light-emitting control signal line EM2 outputs a high level, the first scan signal line SCAN1 outputs a low level, the second scan signal line SCAN2 outputs a high level, and the third scan signal line SCAN3 outputs a low level. In the seventh sub-stage S1-7, the first light-emitting control signal line EM1 outputs a low level, the second light-emitting control signal line EM2 outputs a high level, the first scan signal line SCAN1 outputs a low level, the second scan signal line SCAN2 outputs a high level, and the third scan signal line SCAN3 outputs a low level. In the eighth sub-stage S1-8, the first light-emitting control signal line EM1 outputs a low level, the second light-emitting control signal line EM2 outputs a low level, the first scan signal line SCAN1 outputs a low level, the second scan signal line SCAN2 outputs a high level, and the third scan signal line SCAN3 outputs a low level.

In some embodiments, the driving cycle further includes a second stage S2 following the first stage S1. The second stage S2 includes a ninth sub-stage S2-1, a tenth sub-stage S2-2, an eleventh sub-stage S2-3, a twelfth sub-stage S2-4, a thirteenth sub-stage S2-5, a fourteenth sub-stage S2-6, a fifteenth sub-stage S2-7, and a sixteenth sub-stage S2-8. In the ninth sub-stage S2-1, the first light-emitting control signal line EM1 outputs a low level, the second light-emitting control signal line EM2 outputs a high level, the first scan signal line SCAN1 outputs a low level, the second scan signal line SCAN2 outputs a high level, and the third scan signal line SCAN3 outputs a low level. In the tenth sub-stage S2-2, the first light-emitting control signal line EM1 outputs a high level, the second light-emitting control signal line EM2 outputs a high level, the first scan signal line SCAN1 outputs a low level, the second scan signal line SCAN2 outputs a high level, and the third scan signal line SCAN3 first outputs a low level and then outputs a high level. In the eleventh sub-stage S2-3, the first light-emitting control signal line EM1 outputs a high level, the second light-emitting control signal line EM2 outputs a high level, the first scan signal line SCAN1 outputs a low level, the second scan signal line SCAN2 outputs a high level, and the third scan signal line SCAN3 outputs a low level. In the twelfth sub-stage S2-4, the first light-emitting control signal line EM1 outputs a high level, the second light-emitting control signal line EM2 outputs a high level, the first scan signal line SCAN1 outputs a low level, the second scan signal line SCAN2 outputs a high level, and the third scan signal line SCAN3 first outputs a low level, then a high level, and then a low level. In the thirteenth sub-stage S2-5, the first light-emitting control signal line EM1 outputs a high level, the second light-emitting control signal line EM2 outputs a low level, the first scan signal line SCAN1 outputs a low level, the second scan signal line SCAN2 outputs a high level, and the third scan signal line SCAN3 outputs a low level. In the fourteenth sub-stage S2-6, the first light-emitting control signal line EM1 outputs a high level, the second light-emitting control signal line EM2 outputs a high level, the first scan signal line SCAN1 outputs a low level, the second scan signal line SCAN2 outputs a high level, and the third scan signal line SCAN3 outputs a low level. In the fifteenth sub-stage S2-7, the first light-emitting control signal line EM1 outputs a low level, the second light-emitting control signal line EM2 outputs a high level, the first scan signal line SCAN1 outputs a low level, the second scan signal line SCAN2 outputs a high level, and the third scan signal line SCAN3 outputs a low level. In the sixteenth sub-stage S2-8, the first light-emitting control signal line EM1 outputs a low level, the second light-emitting control signal line EM2 outputs a low level, the first scan signal line SCAN1 outputs a low level, the second scan signal line SCAN2 outputs a high level, and the third scan signal line SCAN3 outputs a low level.

In some embodiments, the first transistor T1, the second transistor T2, the third transistor T3, the fourth transistor T4, and the seventh transistor T7 are N-type thin-film transistors, and the fifth transistor T5 and the sixth transistor T6 are P-type thin-film transistors. In this embodiment, the high and low levels of the signal output by the second scan signal line SCAN2 are opposite to those in embodiments where the first transistor T1, the third transistor T3, the fourth transistor T4, and the seventh transistor T7 are N-type thin-film transistors, and the second transistor T2, the fifth transistor T5, and the sixth transistor T6 are P-type thin-film transistors; the signals output by other signal lines remain unchanged.

In some embodiments, the first stage S1 includes a first sub-stage S1-1, a second sub-stage S1-2, a third sub-stage S1-3, a fourth sub-stage S1-4, a fifth sub-stage S1-5, a sixth sub-stage S1-6, a seventh sub-stage S1-7, and an eighth sub-stage S1-8. In the first sub-stage S1-1, the first light-emitting control signal line EM1 outputs a low level, the second light-emitting control signal line EM2 outputs a high level, the first scan signal line SCAN1 first outputs a low level and then a high level, the second scan signal line SCAN2 outputs a low level, and the third scan signal line SCAN3 outputs a low level. In the second sub-stage S1-2, the first light-emitting control signal line EM1 outputs a high level, the second light-emitting control signal line EM2 outputs a high level, the first scan signal line SCAN1 outputs a high level, the second scan signal line SCAN2 outputs a low level, and the third scan signal line SCAN3 first outputs a low level and then a high level. In the third sub-stage S1-3, the first light-emitting control signal line EM1 outputs a high level, the second light-emitting control signal line EM2 outputs a high level, the first scan signal line SCAN1 outputs a high level, the second scan signal line SCAN2 first outputs a low level, then a high level, then a low level, and the third scan signal line SCAN3 outputs a low level. In the fourth sub-stage S1-4, the first light-emitting control signal line EM1 outputs a high level, the second light-emitting control signal line EM2 outputs a high level, the first scan signal line SCAN1 outputs a low level, the second scan signal line SCAN2 outputs a low level, and the third scan signal line SCAN3 first outputs a low level, then a high level, then a low level. In the fifth sub-stage S1-5, the first light-emitting control signal line EM1 outputs a high level, the second light-emitting control signal line EM2 outputs a low level, the first scan signal line SCAN1 outputs a low level, the second scan signal line SCAN2 outputs a low level, and the third scan signal line SCAN3 outputs a low level. In the sixth sub-stage S1-6, the first light-emitting control signal line EM1 outputs a high level, the second light-emitting control signal line EM2 outputs a high level, the first scan signal line SCAN1 outputs a low level, the second scan signal line SCAN2 outputs a low level, and the third scan signal line SCAN3 outputs a low level. In the seventh sub-stage S1-7, the first light-emitting control signal line EM1 outputs a low level, the second light-emitting control signal line EM2 outputs a high level, the first scan signal line SCAN1 outputs a low level, the second scan signal line SCAN2 outputs a low level, and the third scan signal line SCAN3 outputs a low level. In the eighth sub-stage S1-8, the first light-emitting control signal line EM1 outputs a low level, the second light-emitting control signal line EM2 outputs a low level, the first scan signal line SCAN1 outputs a low level, the second scan signal line SCAN2 outputs a low level, and the third scan signal line SCAN3 outputs a low level.

In some embodiments, the driving cycle further includes a second stage S2 following the first stage S1. The second stage S2 includes a ninth sub-stage S2-1, a tenth sub-stage S2-2, an eleventh sub-stage S2-3, a twelfth sub-stage S2-4, a thirteenth sub-stage S2-5, a fourteenth sub-stage S2-6, a fifteenth sub-stage S2-7, and a sixteenth sub-stage S2-8. In the ninth sub-stage S2-1, the first light-emitting control signal line EM1 outputs a low level, the second light-emitting control signal line EM2 outputs a high level, the first scan signal line SCAN1 outputs a low level, the second scan signal line SCAN2 outputs a low level, and the third scan signal line SCAN3 outputs a low level. In the tenth sub-stage S2-2, the first light-emitting control signal line EM1 outputs a high level, the second light-emitting control signal line EM2 outputs a high level, the first scan signal line SCAN1 outputs a low level, the second scan signal line SCAN2 outputs a low level, and the third scan signal line SCAN3 first outputs a low level and then outputs a high level. In the eleventh sub-stage S2-3, the first light-emitting control signal line EM1 outputs a high level, the second light-emitting control signal line EM2 outputs a high level, the first scan signal line SCAN1 outputs a low level, the second scan signal line SCAN2 outputs a low level, and the third scan signal line SCAN3 outputs a low level. In the twelfth sub-stage S2-4, the first light-emitting control signal line EM1 outputs a high level, the second light-emitting control signal line EM2 outputs a high level, the first scan signal line SCAN1 outputs a low level, the second scan signal line SCAN2 outputs a low level, and the third scan signal line SCAN3 first outputs a low level, then a high level, and then a low level. In the thirteenth sub-stage S2-5, the first light-emitting control signal line EM1 outputs a high level, the second light-emitting control signal line EM2 outputs a low level, the first scan signal line SCAN1 outputs a low level, the second scan signal line SCAN2 outputs a low level, and the third scan signal line SCAN3 outputs a low level. In the fourteenth sub-stage S2-6, the first light-emitting control signal line EM1 outputs a high level, the second light-emitting control signal line EM2 outputs a high level, the first scan signal line SCAN1 outputs a low level, the second scan signal line SCAN2 outputs a low level, and the third scan signal line SCAN3 outputs a low level. In the fifteenth sub-stage S2-7, the first light-emitting control signal line EM1 outputs a low level, the second light-emitting control signal line EM2 outputs a high level, the first scan signal line SCAN1 outputs a low level, the second scan signal line SCAN2 outputs a low level, and the third scan signal line SCAN3 outputs a low level. In the sixteenth sub-stage S2-8, the first light-emitting control signal line EM1 outputs a low level, the second light-emitting control signal line EM2 outputs a low level, the first scan signal line SCAN1 outputs a low level, the second scan signal line SCAN2 outputs a low level, and the third scan signal line SCAN3 outputs a low level.

Embodiments of this application also provide a driving method for a display device, which is applicable to the aforementioned display device. As shown in FIGS. 3 and 4, in this driving method, when the display device switches from a first refresh rate to a second refresh rate, the driving cycle for displaying one frame at the second refresh rate includes a first stage S1 and a second stage S2, where the first refresh rate is higher than the second refresh rate. Before the light-emitting device emits light, the driving method first controls the fourth transistor T4 to turn on, and resets the other of the source and drain of the sixth transistor T6 through the first reset signal line VI. Then, it controls the seventh transistor T7 to turn on, and resets the other of the source and drain of the first transistor T1 through the second reset signal line Vref. Then, it controls the fourth transistor T4 to turn off and the sixth transistor T6 to turn on, and resets the other of the source and drain of the first transistor T1 through the other of the source and drain of the sixth transistor T6. Finally, it controls the fifth transistor T5 to turn on, and resets the one of the source and drain of the first transistor T1 through the first power supply signal line VDD. Based on this driving method, in the first stage S1 and the second stage S2, before the light-emitting device emits light, the relevant nodes are reset sequentially, so that the potentials of these nodes are close before the light-emitting device emits light in the first stage S1 and the second stage S2, thereby reducing the potential difference of the relevant nodes before the light-emitting device emits light in the first stage S1 and the second stage S2, thereby improving the brightness flicker phenomenon that occurs in the display device during refresh rate switching, and reducing the color deviation of the image displayed by the display device before and after refresh rate switching.

When the display device displays a frame at a refresh rate of 120 Hz, the driving cycle for the display device to display one frame includes the first sub-stage S1-1, the second sub-stage S1-2, the third sub-stage S1-3, the fourth sub-stage S1-4, the fifth sub-stage S1-5, the sixth sub-stage S1-6, the seventh sub-stage S1-7, and the eighth sub-stage S1-8.

In the first sub-stage S1-1, the first light-emitting control signal line EM1 outputs a low level, the second light-emitting control signal line EM2 outputs a high level, the first scan signal line SCAN1 first outputs a low level and then a high level, the second scan signal line SCAN2 outputs a high level, and the third scan signal line SCAN3 outputs a low level. The third transistor T3, the fourth transistor T4, and the fifth transistor T5 are turned on, while the second transistor T2, the sixth transistor T6, and the seventh transistor T7 are turned off. The first reset signal line VI resets the fourth node C through the fourth transistor T4, and the first power supply signal line VDD resets the second node Q through the fifth transistor T5 and the third transistor T3. In the first sub-stage S1-1, the first transistor T1 is temporarily turned on during the voltage rise at the second node Q, but because the sixth transistor T6 is turned off, the light-emitting device is not turned on.

In the second sub-stage S1-2, the first light-emitting control signal line EM1 outputs a high level, the second light-emitting control signal line EM2 outputs a high level, the first scan signal line SCAN1 outputs a high level, the second scan signal line SCAN2 outputs a high level, and the third scan signal line SCAN3 first outputs a low level and then outputs a high level. The first transistor T1, the third transistor T3, the fourth transistor T4, and the seventh transistor T7 are turned on, while the second transistor T2, the fifth transistor T5, and the sixth transistor T6 are turned off. The second reset signal line Vref resets the second node Q through the seventh transistor T7, the first transistor T1, and the third transistor T3. Since the first power supply signal line VDD resets the second node Q in the first sub-stage S1-1, the potential of the second node Q is positive. The first transistor T1 is an N-type thin-film transistor. The potential of the second reset signal line Vref is lower than the potential of the first power supply signal line VDD. The difference between the gate voltage and source voltage of the first transistor T1 is greater than the threshold voltage Vth of the first transistor T1, so the first transistor T1 is turned on. The second reset signal line Vref resets the second node Q through the seventh transistor T7, the first transistor T1, and the third transistor T3. When the potential of the second node Q reaches a value equal to the sum of the potential of the second reset signal line Vref and the threshold voltage Vth of the first transistor T1, the difference between the gate voltage and source voltage of the first transistor T1 equals the threshold voltage Vth of the first transistor T1. The first transistor T1 is turned off, and the potential of the second node Q is clamped to a value equal to the sum of the potential of the second reset signal line Vref and the threshold voltage Vth of the first transistor T1, and no longer changes.

In the third sub-stage S1-3, the first light-emitting control signal line EM1 outputs a high level, the second light-emitting control signal line EM2 outputs a high level, the first scan signal line SCAN1 outputs a high level, the second scan signal line SCAN2 first outputs a high level, then a low level, then a high level again, and the third scan signal line SCAN3 outputs a low level. During the period when the second scan signal line SCAN2 outputs a low level, the first transistor T1, the second transistor T2, the third transistor T3, and the fourth transistor T4 are turned on, while the fifth transistor T5, the sixth transistor T6, and the seventh transistor T7 are turned off. The data signal line DATA charges the second node Q through the second transistor T2 and the first transistor T1. When the potential of the second node Q reaches a value equal to the sum of the potential of the data signal line DATA and the threshold voltage Vth of the first transistor T1, the first transistor T1 is turned off, stopping the charging of the second node Q. During the period when the second scan signal line SCAN2 outputs a high level, the second transistor T2 is turned off, while the first transistor T1, the third transistor T3, and the fourth transistor T4 remain on.

In the fourth sub-stage S1-4, the first light-emitting control signal line EM1 outputs a high level, the second light-emitting control signal line EM2 outputs a high level, the first scan signal line SCAN1 outputs a low level, the second scan signal line SCAN2 outputs a high level, and the third scan signal line SCAN3 first outputs a low level, then a high level, and then a low level. During the period when the third scan signal line SCAN3 outputs a high level, the fourth transistor T4 and the seventh transistor T7 are turned on, while the second transistor T2, the third transistor T3, the fifth transistor T5, and the sixth transistor T6 are turned off. The second reset signal line Vref resets the first node B through the seventh transistor T7. During the period when the third scan signal line SCAN3 outputs a low level, the seventh transistor T7 is turned off, and the first transistor T1 remains on.

In the fifth sub-stage S1-5, the first light-emitting control signal line EM1 outputs a high level, the second light-emitting control signal line EM2 outputs a low level, the first scan signal line SCAN1 outputs a low level, the second scan signal line SCAN2 outputs a high level, and the third scan signal line SCAN3 outputs a low level. The first transistor T1 and the sixth transistor T6 are turned on, while the second transistor T2, the third transistor T3, the fourth transistor T4, the fifth transistor T5, and the seventh transistor T7 are turned off. The fourth node C is connected to the first node B through the sixth transistor T6, resetting the first node B. In the fifth sub-stage S1-5, the first transistor T1 remains on due to its high gate voltage.

In the sixth sub-stage S1-6, the first light-emitting control signal line EM1 outputs a high level, the second light-emitting control signal line EM2 outputs a high level, the first scan signal line SCAN1 outputs a low level, the second scan signal line SCAN2 outputs a high level, and the third scan signal line SCAN3 outputs a low level. The first transistor T1 and the fourth transistor T4 are turned on, while the second transistor T2, the third transistor T3, the fifth transistor T5, the sixth transistor T6, and the seventh transistor T7 are turned off. The first reset signal line VI resets the fourth node C through the fourth transistor T4.

In the seventh sub-stage S1-7, the first light-emitting control signal line EM1 outputs a low level, the second light-emitting control signal line EM2 outputs a high level, the first scan signal line SCAN1 outputs a low level, the second scan signal line SCAN2 outputs a high level, and the third scan signal line SCAN3 outputs a low level. The first transistor T1, the fourth transistor T4, and the fifth transistor T5 are turned on, while the second transistor T2, the third transistor T3, the sixth transistor T6, and the seventh transistor T7 are turned off. The first power supply signal line VDD resets the third node A through the fifth transistor T5.

In the eighth sub-stage S1-8, the first light-emitting control signal line EM1 outputs a low level, the second light-emitting control signal line EM2 outputs a low level, the first scan signal line SCAN1 outputs a low level, the second scan signal line SCAN2 outputs a high level, and the third scan signal line SCAN3 outputs a low level. The first transistor T1, the fifth transistor T5, and the sixth transistor T6 are turned on, while the second transistor T2, the third transistor T3, the fourth transistor T4, and the seventh transistor T7 are turned off. A conductive path is formed between the first power supply signal line VDD and the second power supply signal line VSS, and the light-emitting device emits light. The current flowing through the light-emitting device is proportional to the square of the difference between the potential of the data signal line DATA and the potential of the first reset signal line VI.

When the display device switches from a refresh rate of 120 Hz to a refresh rate of 1 Hz, the display device is configured to use a frame skipping method to achieve the switch from 120 Hz to 1 Hz. When the display device displays an image at a refresh rate of 1 Hz, the driving cycle for displaying one frame includes a first stage S1 and a second stage S2. The duration of the first stage S1 is shorter than the duration of the second stage S2.

The first stage S1 includes the first sub-stage S1-1, the second sub-stage S1-2, the third sub-stage S1-3, the fourth sub-stage S1-4, the fifth sub-stage S1-5, the sixth sub-stage S1-6, the seventh sub-stage S1-7, and the eighth sub-stage S1-8. When the display device displays the image at a refresh rate of 1 Hz, the driving process of the first sub-stages S1-1 to the eighth sub-stages S1-8 of the first stage S1 is the same as the driving process of the first sub-stages S1-1 to the eighth sub-stages S1-8 when the display device displays the image at a refresh rate of 120 Hz.

In the first sub-stage S1-1, the first light-emitting control signal line EM1 outputs a low level, the second light-emitting control signal line EM2 outputs a high level, the first scan signal line SCAN1 first outputs a low level and then outputs a high level, the second scan signal line SCAN2 outputs a high level, and the third scan signal line SCAN3 outputs a low level.

In the second sub-stage S1-2, the first light-emitting control signal line EM1 outputs a high level, the second light-emitting control signal line EM2 outputs a high level, the first scan signal line SCAN1 outputs a high level, the second scan signal line SCAN2 outputs a high level, and the third scan signal line SCAN3 first outputs a low level and then outputs a high level.

In the third sub-stage S1-3, the first light-emitting control signal line EM1 outputs a high level, the second light-emitting control signal line EM2 outputs a high level, the first scan signal line SCAN1 outputs a high level, the second scan signal line SCAN2 first outputs a high level, then a low level, then a high level, and the third scan signal line SCAN3 outputs a low level.

In the fourth sub-stage S1-4, the first light-emitting control signal line EM1 outputs a high level, the second light-emitting control signal line EM2 outputs a high level, the first scan signal line SCAN1 outputs a low level, the second scan signal line SCAN2 outputs a high level, and the third scan signal line SCAN3 first outputs a low level, then a high level, and then a low level.

In the fifth sub-stage S1-5, the first light-emitting control signal line EM1 outputs a high level, the second light-emitting control signal line EM2 outputs a low level, the first scan signal line SCAN1 outputs a low level, the second scan signal line SCAN2 outputs a high level, and the third scan signal line SCAN3 outputs a low level.

In the sixth sub-stage S1-6, the first light-emitting control signal line EM1 outputs a high level, the second light-emitting control signal line EM2 outputs a high level, the first scan signal line SCAN1 outputs a low level, the second scan signal line SCAN2 outputs a high level, and the third scan signal line SCAN3 outputs a low level.

In the seventh sub-stage S1-7, the first light-emitting control signal line EM1 outputs a low level, the second light-emitting control signal line EM2 outputs a high level, the first scan signal line SCAN1 outputs a low level, the second scan signal line SCAN2 outputs a high level, and the third scan signal line SCAN3 outputs a low level.

In the eighth sub-stage S1-8, the first light-emitting control signal line EM1 outputs a low level, the second light-emitting control signal line EM2 outputs a low level, the first scan signal line SCAN1 outputs a low level, the second scan signal line SCAN2 outputs a high level, and the third scan signal line SCAN3 outputs a low level.

The second stage S2 includes the ninth sub-stage S2-1, the tenth sub-stage S2-2, the eleventh sub-stage S2-3, the twelfth sub-stage S2-4, the thirteenth sub-stage S2-5, the fourteenth sub-stage S2-6, the fifteenth sub-stage S2-7, and the sixteenth sub-stage S2-8.

In the ninth sub-stage S2-1, the first light-emitting control signal line EM1 outputs a low level, the second light-emitting control signal line EM2 outputs a high level, the first scan signal line SCAN1 outputs a low level, the second scan signal line SCAN2 outputs a high level, and the third scan signal line SCAN3 outputs a low level. The first transistor T1, the fourth transistor T4, and the fifth transistor T5 are turned on, while the second transistor T2, the third transistor T3, the sixth transistor T6, and the seventh transistor T7 are turned off. The first reset signal line VI resets the fourth node C through the fourth transistor T4, and the first power supply signal line VDD resets the third node A through the fifth transistor T5.

In the tenth sub-stage S2-2, the first light-emitting control signal line EM1 outputs a high level, the second light-emitting control signal line EM2 outputs a high level, the first scan signal line SCAN1 outputs a low level, the second scan signal line SCAN2 outputs a high level, and the third scan signal line SCAN3 first outputs a low level and then outputs a high level. During the period when the third scan signal line SCAN3 outputs a high level, the first transistor T1, the fourth transistor T4, and the seventh transistor T7 are turned on, while the second transistor T2, the third transistor T3, the fifth transistor T5, and the sixth transistor T6 are turned off. The second reset signal line Vref resets the first node B through the seventh transistor T7.

In the eleventh sub-stage S2-3, the first light-emitting control signal line EM1 outputs a high level, the second light-emitting control signal line EM2 outputs a high level, the first scan signal line SCAN1 outputs a low level, the second scan signal line SCAN2 outputs a high level, and the third scan signal line SCAN3 outputs a low level. The first transistor T1 and the fourth transistor T4 are turned on, while the second transistor T2, the third transistor T3, the fifth transistor T5, the sixth transistor T6, and the seventh transistor T7 are turned off. The first reset signal line VI resets the fourth node C through the fourth transistor T4.

In the twelfth sub-stage S2-4, the first light-emitting control signal line EM1 outputs a high level, the second light-emitting control signal line EM2 outputs a high level, the first scan signal line SCAN1 outputs a low level, the second scan signal line SCAN2 outputs a high level, and the third scan signal line SCAN3 first outputs a low level, then a high level, and then a low level. During the period when the third scan signal line SCAN3 outputs a high level, the first transistor T1, the fourth transistor T4, and the seventh transistor T7 are turned on, while the second transistor T2, the third transistor T3, the fifth transistor T5, and the sixth transistor T6 are turned off. The second reset signal line Vref resets the first node B through the seventh transistor T7.

In the thirteenth sub-stage S2-5, the first light-emitting control signal line EM1 outputs a high level, the second light-emitting control signal line EM2 outputs a low level, the first scan signal line SCAN1 outputs a low level, the second scan signal line SCAN2 outputs a high level, and the third scan signal line SCAN3 outputs a low level. The first transistor T1 and the sixth transistor T6 are turned on, while the second transistor T2, the third transistor T3, the fourth transistor T4, the fifth transistor T5, and the seventh transistor T7 are turned off. The fourth node C is connected to the first node B through the sixth transistor T6, resetting the first node B.

In the fourteenth sub-stage S2-6, the first light-emitting control signal line EM1 outputs a high level, the second light-emitting control signal line EM2 outputs a high level, the first scan signal line SCAN1 outputs a low level, the second scan signal line SCAN2 outputs a high level, and the third scan signal line SCAN3 outputs a low level. The first transistor T1 and the fourth transistor T4 are turned on, while the second transistor T2, the third transistor T3, the fifth transistor T5, the sixth transistor T6, and the seventh transistor T7 are turned off. The first reset signal line VI resets the fourth node C through the fourth transistor T4.

In the fifteenth sub-stage S2-7, the first light-emitting control signal line EM1 outputs a low level, the second light-emitting control signal line EM2 outputs a high level, the first scan signal line SCAN1 outputs a low level, the second scan signal line SCAN2 outputs a high level, and the third scan signal line SCAN3 outputs a low level. The first transistor T1, the fourth transistor T4, and the fifth transistor T5 are turned on, while the second transistor T2, the third transistor T3, the sixth transistor T6, and the seventh transistor T7 are turned off. The first power supply signal line VDD resets the third node A through the fifth transistor T5.

In the sixteenth sub-stage S2-8, the first light-emitting control signal line EM1 outputs a low level, the second light-emitting control signal line EM2 outputs a low level, the first scan signal line SCAN1 outputs a low level, the second scan signal line SCAN2 outputs a high level, and the third scan signal line SCAN3 outputs a low level. The first transistor T1, the fifth transistor T5, and the sixth transistor T6 are turned on, while the second transistor T2, the third transistor T3, the fourth transistor T4, and the seventh transistor T7 are turned off. A conductive path is formed between the first power supply signal line VDD and the second power supply signal line VSS, and the light-emitting device emits light. The current flowing through the light-emitting device is proportional to the square of the difference between the potential of the data signal line DATA and the potential of the first reset signal line VI.

Based on the above driving method, when the display device switches from a refresh rate of 120 Hz to a refresh rate of 1 Hz, in the first stage S1 and the second stage S2, before the light-emitting device emits light, the fourth transistor T4 is first turned on, and the other of the source and drain of the sixth transistor T6 is reset through the first reset signal line VI. Then, the seventh transistor T7 is turned on. The other of the source and drain of the first transistor T1 is reset through the second reset signal line Vref. Then, the fourth transistor T4 is turned off, and the sixth transistor T6 is turned on. The other of the source and drain of the first transistor T1 is reset through the other of the source and drain of the sixth transistor T6. Then, the fifth transistor T5 is turned on, and the one of the source and drain of the first transistor T1 is reset through the first power supply signal line VDD. By resetting the fourth node C, the first node B, and the third node A in sequence, the potentials of the third node A and the first node B before the light-emitting device emits light in the first stage S1 and the second stage S2 are made close, thereby reducing the potential difference between the third node A and the first node B before the light-emitting device emits light in the first stage S1 and the second stage S2. This improves the brightness flicker phenomenon that occurs during refresh rate switching of the display device and reduces the color deviation of the image displayed by the display device before and after refresh rate switching.

The display device may also include at least one processor, which can be various general-purpose and/or special-purpose processing components with processing and computing capabilities. Some examples of processors include, but are not limited to, central processing units (CPUs), graphics processing units (GPUs), various dedicated artificial intelligence (AI) computing chips, various processors running machine learning model algorithms, digital signal processors (DSPs), and any suitable processors, controllers, microcontrollers, etc. The processor is configured to control the individual transistors as described above.

In some embodiments, the control of the individual transistors may be implemented as a computer program tangibly embodied in a computer-readable storage medium. The computer-readable storage medium may be a tangible medium that can contain or store a computer program for use by or in connection with an instruction execution system, apparatus, or device. The computer-readable storage medium may include, but is not limited to, electronic, magnetic, optical, electromagnetic, infrared, or semiconductor systems, apparatuses, or devices, or any suitable combination of the foregoing. Alternatively, the computer-readable storage medium may be a machine-readable signal medium. More specific examples of machine-readable storage media would include an electrical connection having one or more wires, a portable computer disk, a hard disk, random access memory (RAM), read-only memory (ROM), erasable programmable read-only memory (EPROM or flash memory), fiber optics, a portable compact disc read-only memory (CD-ROM), optical storage devices, magnetic storage devices, or any suitable combination of the foregoing.

The embodiments of this application have been described in detail above. The content of this specification should not be construed as limiting the scope of protection of this application.

What is claimed is:

1. A display device, comprising:
a display panel, comprising:
a plurality of third scan signal lines;
a plurality of first light-emitting control signal lines;
a plurality of second light-emitting control signal lines;
at least one first power supply signal line;
a plurality of first reset signal lines;
a plurality of second reset signal lines; and
a plurality of pixels, each comprising:
a light-emitting device; and
a pixel driving circuit, comprising:
a first transistor, comprising:
at least one gate;
a source; and
a drain;
a fourth transistor, comprising:
a gate electrically connected to one of the second light-emitting control signal lines;
a source; and
a drain;
a fifth transistor, comprising:
a gate electrically connected to one of the first light-emitting control signal lines;
a source; and
a drain;
a sixth transistor, comprising:
a gate electrically connected to one of the second light-emitting control signal lines;
a source; and
a drain; and
a seventh transistor, comprising:
a gate electrically connected to one of the third scan signal lines;
a source; and
a drain;
wherein,
one of the source or the drain of the fifth transistor is electrically connected to the first power supply signal line, another of the source or the drain of the fifth transistor is electrically connected to one of the source or the drain of the first transistor;
one of the source or the drain of the sixth transistor is electrically connected to another of the source or the drain of the first transistor, another of the source or the drain of the sixth transistor is electrically connected to an anode of the light-emitting device;
one of the source or the drain of the fourth transistor is electrically connected to one of the first reset signal lines, another of the source or the drain of the fourth transistor is electrically connected to the other of the source or the drain of the sixth transistor;
one of the source or the drain of the seventh transistor is electrically connected to one of the second reset signal lines, another of the source or the drain of the seventh transistor is electrically connected to the other of the source or the drain of the first transistor;
wherein, when the display device switches from a first refresh rate to a second refresh rate lower than the first refresh rate, a driving cycle for displaying a frame at the second refresh rate comprises a first stage and a second stage;
in the first stage, the display device is configured to control the fourth transistor to turn off and the sixth transistor to turn on before the light-emitting device emits light, so as to reset the other of the source or the drain of the first transistor via the other of the source or the drain of the sixth transistor.

2. The display device of claim 1, wherein the display device is configured to control the fourth transistor to turn on before controlling the fourth transistor to turn off and the sixth transistor to turn on, so as to reset the other of the source or the drain of the sixth transistor via the first reset signal line.

3. The display device of claim 2, wherein the display device is configured to control the seventh transistor to turn on after controlling the fourth transistor to turn on and before controlling the fourth transistor to turn off, so as to reset the other of the source or the drain of the first transistor via the second reset signal line.

4. The display device of claim 1, wherein the display device is configured to control the fifth transistor to turn on after controlling the fourth transistor to turn off and the sixth transistor to turn on, so as to reset the one of the source or the drain of the first transistor via the first power supply signal line.

5. The display device of claim 1,
wherein the display panel further comprises:
a plurality of first scan signal lines;
a plurality of second scan signal lines;
a plurality of data signal lines; and
at least one second power supply signal line;
wherein the pixel driving circuit further comprises:
a second transistor;
a third transistor; and
a storage capacitor;
wherein a first gate of the first transistor is electrically connected to one of the source or the drain of the third transistor, and the one of the source or the drain of the first transistor is electrically connected to another of the source or the drain of the third transistor;
a gate of the second transistor is electrically connected to one of the second scan signal lines, one of the source or the drain of the second transistor is electrically connected to one of the data signal lines, and another of the source or the drain of the second transistor is electrically connected to the other of the source or the drain of the first transistor;
a gate of the third transistor is electrically connected to one of the first scan signal lines;
an end of the storage capacitor is electrically connected to the first gate of the first transistor, and another end of the storage capacitor is electrically connected to the other of the source or the drain of the fourth transistor;
a cathode of the light-emitting device is electrically connected to the second power supply signal line;
the first transistor, the third transistor, the fourth transistor, and the seventh transistor are N-type thin-film transistors, and the second transistor, the fifth transistor, and the sixth transistor are P-type thin-film transistors;
wherein before the light-emitting device emits light, the first stage comprises:
a fifth sub-stage, during which the first light-emitting control signal line outputs a high level, the second light-emitting control signal line outputs a low level, the first scan signal line outputs a low level, the second scan signal line outputs a high level, and the third scan signal line outputs a low level.

6. The display device of claim 5, wherein, before the fifth sub-stage, the first stage further comprises:
a fourth sub-stage, during which the first light-emitting control signal line outputs a high level, the second light-emitting control signal line outputs a high level, the first scan signal line outputs a low level, the second scan signal line outputs a high level, and the third scan signal line sequentially outputs a low level, a high level, and a low level.

7. The display device of claim 6,
wherein, before the fourth sub-stage, the first stage further comprises:
a first sub-stage, during which the first light-emitting control signal line outputs a low level, the second light-emitting control signal line outputs a high level, the first scan signal line sequentially outputs a low level and a high level, the second scan signal line outputs a high level, and the third scan signal line outputs a low level;
a second sub-stage, during which the first light-emitting control signal line outputs a high level, the second light-emitting control signal line outputs a high level, the first scan signal line outputs a high level, the second scan signal line outputs a high level, and the third scan signal line sequentially outputs a low level and a high level; and
a third sub-stage, during which the first light-emitting control signal line outputs a high level, the second light-emitting control signal line outputs a high level, the first scan signal line outputs a high level, the second scan signal line sequentially outputs a high level, a low level, and a high level, and the third scan signal line outputs a low level;
wherein, after the fifth sub-stage, the first stage further comprises:
a sixth sub-stage, during which the first light-emitting control signal line outputs a high level, the second light-emitting control signal line outputs a high level, the first scan signal line outputs a low level, the second scan signal line outputs a high level, and the third scan signal line outputs a low level;
a seventh sub-stage, during which the first light-emitting control signal line outputs a low level, the second light-emitting control signal line outputs a high level, the first scan signal line outputs a low level, the second scan signal line outputs a high level, and the third scan signal line outputs a low level; and
an eighth sub-stage, during which the first light-emitting control signal line outputs a low level, the second light-emitting control signal line outputs a low level, the first scan signal line outputs a low level, the second scan signal line outputs a high level, and the third scan signal line outputs a low level.

8. The display device of claim 5, wherein the second stage comprises:
a thirteenth sub-stage, during which the first light-emitting control signal line outputs a high level, the second light-emitting control signal line outputs a low level, the first scan signal line outputs a low level, the second scan signal line outputs a high level, and the third scan signal line outputs a low level.

9. The display device of claim 8, wherein, before the thirteenth sub-stage, the second stage further comprises:
a twelfth sub-stage, during which the first light-emitting control signal line outputs a high level, the second light-emitting control signal line outputs a high level, the first scan signal line outputs a low level, the second scan signal line outputs a high level, and the third scan signal line sequentially outputs a low level, a high level, and a low level.

10. The display device of claim 9, wherein, before the twelfth sub-stage, the second stage further comprises:
a ninth sub-stage, during which the first light-emitting control signal line outputs a low level, the second light-emitting control signal line outputs a high level, the first scan signal line outputs a low level, the second scan signal line outputs a high level, and the third scan signal line outputs a low level;
a tenth sub-stage, during which the first light-emitting control signal line outputs a high level, the second light-emitting control signal line outputs a high level, the first scan signal line outputs a low level, the second scan signal line outputs a high level, and the third scan signal line sequentially outputs a low level and a high level; and
an eleventh sub-stage, during which the first light-emitting control signal line outputs a high level, the second light-emitting control signal line outputs a high level, the first scan signal line outputs a low level, the second scan signal line outputs a high level, and the third scan signal line outputs a low level;
wherein after the thirteenth sub-stage, the second stage further comprises:
a fourteenth sub-stage, during which the first light-emitting control signal line outputs a high level, the second light-emitting control signal line outputs a high level, the first scan signal line outputs a low level, the second scan signal line outputs a high level, and the third scan signal line outputs a low level;
a fifteenth sub-stage, during which the first light-emitting control signal line outputs a low level, the second light-emitting control signal line outputs a high level, the first scan signal line outputs a low level, the second scan signal line outputs a high level, and the third scan signal line outputs a low level; and
a sixteenth sub-stage, during which the first light-emitting control signal line outputs a low level, the second light-emitting control signal line outputs a low level, the first scan signal line outputs a low level, the second scan signal line outputs a high level, and the third scan signal line outputs a low level.

11. The display device of claim 1, wherein the display panel further comprises:
a plurality of first scan signal lines;
a plurality of second scan signal lines;
a plurality of data signal lines; and
at least one second power supply signal line;
wherein the pixel driving circuit further comprises:
a second transistor;
a third transistor; and
a storage capacitor;
wherein a first gate of the first transistor is electrically connected to one of the source or the drain of the third transistor, and the one of the source or the drain of the first transistor is electrically connected to another of the source or the drain of the third transistor;
a gate of the second transistor is electrically connected to one of the second scan signal lines, one of the source or the drain of the second transistor is electrically connected to one of the data signal lines, and another of the source or the drain of the second transistor is electrically connected to the other of the source or the drain of the first transistor;
a gate of the third transistor is electrically connected to one of the first scan signal lines;
an end of the storage capacitor is electrically connected to the first gate of the first transistor, and another end of the storage capacitor is electrically connected to the other of the source or the drain of the fourth transistor;
a cathode of the light-emitting device is electrically connected to the second power supply signal line;
the first transistor, the second transistor, the third transistor, the fourth transistor, and the seventh transistor are N-type thin-film transistors, and the fifth transistor and the sixth transistor are P-type thin-film transistors;
wherein, before the light-emitting device emits light, the first stage comprises:
a fifth sub-stage, during which the first light-emitting control signal line outputs a high level, the second light-emitting control signal line outputs a low level, the first scan signal line outputs a low level, the second scan signal line outputs a low level, and the third scan signal line outputs a low level.

12. The display device of claim 11, wherein, before the fifth sub-stage, the first stage further comprises:
a fourth sub-stage, during which the first light-emitting control signal line outputs a high level, the second light-emitting control signal line outputs a high level, the first scan signal line outputs a low level, the second scan signal line outputs a low level, and the third scan signal line sequentially outputs a low level, a high level, and a low level.

13. The display device of claim 12, wherein, before the fourth sub-stage, the first stage further comprises:
a first sub-stage, during which the first light-emitting control signal line outputs a low level, the second light-emitting control signal line outputs a high level, the first scan signal line sequentially outputs a low level and a high level, the second scan signal line outputs a low level, and the third scan signal line outputs a low level;
a second sub-stage, during which the first light-emitting control signal line outputs a high level, the second light-emitting control signal line outputs a high level, the first scan signal line outputs a high level, the second scan signal line outputs a low level, and the third scan signal line sequentially outputs a low level and a high level; and
a third sub-stage, during which the first light-emitting control signal line outputs a high level, the second light-emitting control signal line outputs a high level, the first scan signal line outputs a high level, the second scan signal line sequentially outputs a low level, a high level, and a low level, and the third scan signal line outputs a low level;
wherein, after the fifth sub-stage, the first stage further comprises:
a sixth sub-stage, during which the first light-emitting control signal line outputs a high level, the second light-emitting control signal line outputs a high level, the first scan signal line outputs a low level, the second scan signal line outputs a low level, and the third scan signal line outputs a low level;
a seventh sub-stage, during which the first light-emitting control signal line outputs a low level, the second light-emitting control signal line outputs a high level, the first scan signal line outputs a low level, the second scan signal line outputs a low level, and the third scan signal line outputs a low level; and
an eighth sub-stage, during which the first light-emitting control signal line outputs a low level, the second light-emitting control signal line outputs a low level, the first scan signal line outputs a low level, the second scan signal line outputs a low level, and the third scan signal line outputs a low level.

14. The display device of claim 11, wherein the second stage comprises:
a thirteenth sub-stage, during which the first light-emitting control signal line outputs a high level, the second light-emitting control signal line outputs a low level, the first scan signal line outputs a low level, the second scan signal line outputs a low level, and the third scan signal line outputs a low level.

15. The display device of claim 14, wherein, before the thirteenth sub-stage, the second stage further comprises:
a twelfth sub-stage, during which the first light-emitting control signal line outputs a high level, the second light-emitting control signal line outputs a high level, the first scan signal line outputs a low level, the second scan signal line outputs a low level, and the third scan signal line sequentially outputs a low level, a high level, and a low level.

16. The display device of claim 15, wherein, before the twelfth sub-stage, the second stage further comprises:
a ninth sub-stage, during which the first light-emitting control signal line outputs a low level, the second light-emitting control signal line outputs a high level, the first scan signal line outputs a low level, the second scan signal line outputs a low level, and the third scan signal line outputs a low level;
a tenth sub-stage, during which the first light-emitting control signal line outputs a high level, the second light-emitting control signal line outputs a high level, the first scan signal line outputs a low level, the second scan signal line outputs a low level, and the third scan signal line sequentially outputs a low level and a high level; and
an eleventh sub-stage, during which the first light-emitting control signal line outputs a high level, the second light-emitting control signal line outputs a high level, the first scan signal line outputs a low level, the second scan signal line outputs a low level, and the third scan signal line outputs a low level;
wherein, after the thirteenth sub-stage, the second stage further comprises:
a fourteenth sub-stage, during which the first light-emitting control signal line outputs a high level, the second light-emitting control signal line outputs a high level, the first scan signal line outputs a low level, the second scan signal line outputs a low level, and the third scan signal line outputs a low level;
a fifteenth sub-stage, during which the first light-emitting control signal line outputs a low level, the second light-emitting control signal line outputs a high level, the first scan signal line outputs a low level, the second scan signal line outputs a low level, and the third scan signal line outputs a low level; and
a sixteenth sub-stage, during which the first light-emitting control signal line outputs a low level, the second light-emitting control signal line outputs a low level, the first scan signal line outputs a low level, the second scan signal line outputs a low level, and the third scan signal line outputs a low level.
